(19) United States
(12) Patent Application Publication
(10) Pub. No.: US 2012/0327114 A1
(43) Pub. Date: Dec. 27, 2012

(54) DEVICE AND ASSOCIATED METHODOLOGY FOR PRODUCING AUGMENTED IMAGES

(75) Inventor: David Philippe Sidney NAHON, Paris (FR)

(73) Assignee: DASSAULT SYSTEMES, Velizy Villacoublay Cedex (FR)

(21) Appl. No.: 13/165,507

(22) Filed: Jun. 21, 2011

(51) Int. Cl. G09G 5/00

(52) U.S. Cl. 345/633

(57) ABSTRACT

An augmented image producing device includes a processor programmed receive scene imagery from an imaging device and to identify at least one marker in the scene imagery. The processor then determines whether at least one marker corresponds to a known pattern and if the marker does correspond to a known pattern, the scene imagery is augmented with computer-generated graphics dispersed from a position of the at least one marker. Once the scene imagery is augmented, the computer-generated graphics are displayed on a display screen. The augmented scene imagery can then be used, for example, to actively engage audience members during an event.

### FIELD

The claimed advancements relate to a device and associated methodology for producing augmented images in augmented reality based on markers identified in scene imagery.

### BACKGROUND

Large events, such as conventions or concerts, often employ large display screens for displaying content to be viewed during the event. The display screens are used during the so-called “main event” in order to convey various types of information or entertainment to the viewing audience. The display screens can also be used to entertain the viewing audience before the start of the main event by recording images of the audience and displaying them on the display screen. Therefore, the display screens play an integral role throughout the event such that they are able to convey information to the audience while also actively involving the audience in the event itself.

However, the mere display of the audience on the display screen only keeps the audience entertained for so long before their attention wanders and they begin to get bored by their mere depiction on the display screen. Therefore, a need exists for providing additional entertainment to audience members before and during the main event via the display screen in such a way that keeps the audience members actively involved in the entertainment thereby preventing them from getting bored during the event.

### SUMMARY

In order to solve at least the above-noted problems, the present advancement relates to an augmented image producing device and associated method for producing an augmented image. The augmented image producing device includes a processor programmed to receive scene imagery from an imaging device and to identify at least one marker in the scene imagery. The processor then determines whether at least one marker corresponds to a known pattern and if the marker does correspond to a known pattern, the scene imagery is augmented with computer-generated graphics dispersed from a position of the at least one marker. Once the scene imagery is augmented, the computer-generated graphics are displayed on a display screen.

### BRIEF DESCRIPTION OF THE DRAWINGS

A more complete appreciation of the present advancements and many of the attendant advantages thereof will be readily obtained as the same becomes better understood by reference to the following detailed description when considered in connection with the accompanying drawings. However, the accompanying drawings and their exemplary depictions do not in any way limit the scope of the advancements embraced by this specification. The scope of the advancements embraced by the specification and drawings are defined by the words of the accompanying claims.

FIG. 1 is a schematic diagram of a system for producing augmented images according to an exemplary embodiment of the present advancement;

FIG. 2 is a schematic diagram of a system for producing augmented images according to an exemplary embodiment of the present advancement;

FIG. 3 is an information flow diagram of a system for producing augmented images according to an exemplary embodiment of the present advancement;

FIG. 4 is a an algorithmic flowchart for producing augmented images according to an exemplary embodiment of the present advancement;

FIG. 5a is a schematic diagram of scene imagery before augmentation according to an exemplary embodiment of the present advancement;

FIG. 5b is a schematic diagram of scene imagery after augmentation according to an exemplary embodiment of the present advancement;

FIG. 6 is a step diagram for producing augmented scene imagery according to an exemplary embodiment of the present advancement; and

FIG. 7 is a schematic diagram of an augmented image producing device according to an exemplary embodiment of the present advancement.

### DETAILED DESCRIPTION

Referring now to the drawings, wherein like reference numerals designate identical or corresponding parts throughout the several views, the following description relates to a device and associated methodology for producing augmented images. Specifically, the augmented image producing device receives scene imagery from an imaging device and identifies at least one marker in the scene imagery. It is then determined whether the at least one marker corresponds to a known pattern. The scene imagery is then augmented, in response to determining that the at least one marker corresponds to a known pattern, with computer-generated graphics dispersed from a position of the at least one marker. However, as described further below, other augmentation methods with respect to the scene imagery are within the scope of the present advancement. A display screen is then used to display the augmented scene imagery.

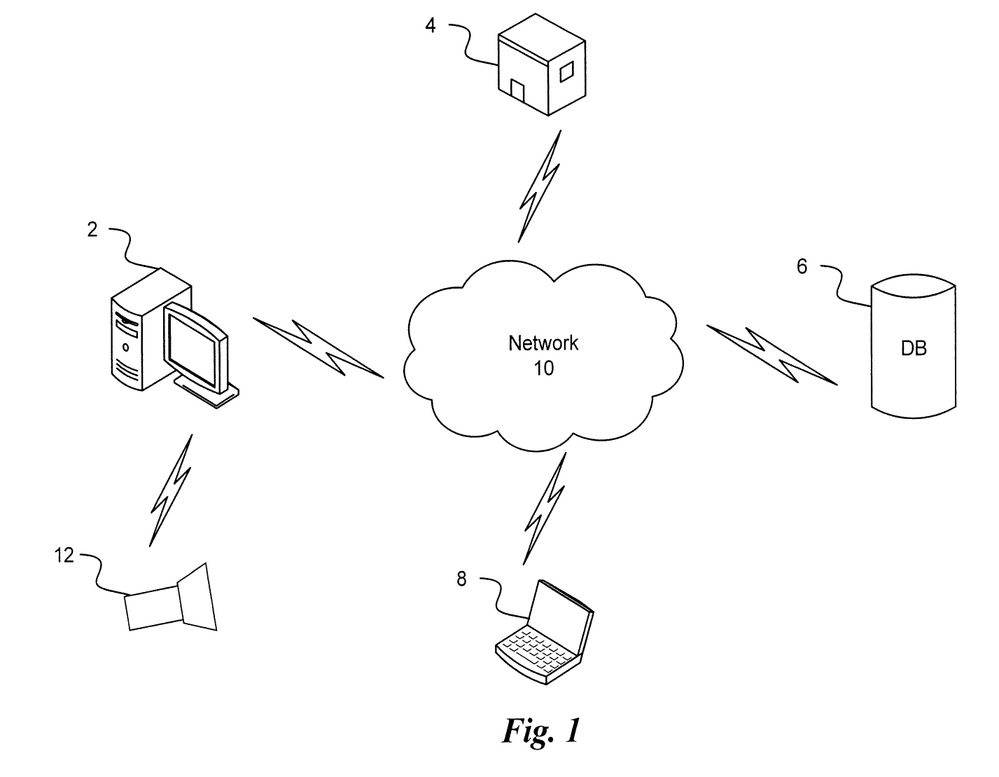

FIG. 1 is a schematic diagram of a system for producing augmented images according to an exemplary embodiment of the present advancement. In FIG. 1, a computer 2 is connected to a server 4, a database 6 and a mobile device 8 via a network 10. The computer is also connected to an imaging device 12 either directly or via the network 10. The imaging device 12 represents one or more image devices that provide scene imagery to the computer 2. The server 4 represents one or more servers connected to the computer 2, the database 6 and the mobile device 8 via the network 10. The database 6 represents one or more databases connected to the computer 2, the server 4 and the mobile device 8 via network 10. The mobile device 8 represents one or more mobile devices connected to the computer 2, the server 4 and the database 6 via the network 10. The network 10 represents one or more networks, such as the Internet, connecting the computer 2, the server 4, the database 6 and the mobile device 8.

The imaging device 12 records image information of a surrounding scene, such as an audience of an event, and sends that information to the computer 2 for processing. The computer 2 processes the received scene imagery from the imaging device 12 in order to determine if there is at least one marker in the scene imagery. Any method of image analysis as would be understood by one of ordinary skill in the art may be used to identify markers in the scene imagery. A marker represents any type of identification pattern in the scene imagery. For example, a marker could be a poster, cardboard cutout, pamphlet, tee shirt logo, hand sign, consumer product or any other pattern discerned from recorded scene imagery as would be understood by one of ordinary skill in the art. The marker can also be identified based on infrared imaging recorded by the imaging device 12. For example, the computer 2, based upon the infrared image recorded by the imaging device 12, could identify a cold soft drink as a marker based upon its heat signature within the infrared scene imagery. In addition, sounds emanating from the scene imagery as recorded by a multidirectional microphone of the imaging device 12 can also be processed by the computer 2 to identify a marker within the scene imagery. The computer 2 then processes the scene imagery to determine whether at least one of the identified markers from the scene imagery corresponds to a known pattern stored either within the computer 2 or remotely on server 4. Any method of pattern matching as would be understood by one of ordinary skill in the art may be used when comparing the identified markers to known patterns.

If a known pattern corresponding to the markers identified from the scene imagery cannot be determined by the computer 2 based on any pattern previously stored within the computer 2, the markers identified by the computer 2 are sent to the server 4 for further processing. Even if the computer 2 identifies a pattern that matches the markers, the markers can still be sent to the server to determine if there are other matches or matches that are more likely. The server 4 uses the information relating to the marker itself to search the database 6 for corresponding patterns. Any matching patterns identified by the server 4 from database 6 are then sent via network 10 to the computer 2 for further processing. If the information from the server 4 includes a matching pattern for the markers, the computer 2 augments the scene imagery received from the imaging device 12 with computer-generated graphics dispersed from a position of the markers in the scene imagery.

In one embodiment of the present advancement, augmented reality is used when augmenting the scene imagery based on a determined matching pattern and the position of the marker in the scene imagery. Thus, the scene imagery recorded by the imaging device 12, which includes physical, real world environments, is augmented by graphics generated by the computer 2. For example, the graphics generated by the computer 2, such as images related to the pattern identified by the computer 2 and/or the server 4 can be included in the real-world footage obtained by the imaging device 12 such that an augmented image is created and displayed to the audience. The augmented image includes imagery of a live scene of the audience at the event while also including computer generated graphics therein based on the identified markers. As described in further detail below, this provides a more interactive type of entertainment that can keep the audience actively engaged for longer periods of time.

In one embodiment of the present advancement, the computer graphics added by the computer 2 to the scene imagery recorded by the imaging device 12 include computer-generated particles emitted by a particle system and/or particle emitter. The particle emitter of the computer 2 utilizes a processor and video card to determine the location and/or orientation and/or movement of the identified markers in 3-D space based on an analysis of the scene imagery recorded by the imaging device 12. The location, orientation and/or movement of the identified markers are then used by the particle emitter to determine where particles will be emitted and in what direction with respect to the markers. The particle emitter includes a variety of behavior parameters identifying such things as the number of particles generated per unit of time, the direction of the emitted particles, the color of the particles and the lifetime of the particles. The particles can represent any type of computer graphic that is to be dispersed and augmented with the scene imagery. For example, the type of particles being dispersed could be based on the content included on the identified markers or based on the matching pattern determined by the computer 2 and/or server 4. As such, the particles emitted could represent a company logo or image typically associated with the pattern corresponding to the identified marker. Further, the number of particle emitters used by the computer 2 may correspond to the number of markers identified within the scene imagery such that individual particle emitters are assigned to control the particles emitted from individual markers. This can be accomplished by assigning different IDs to different markers and matching the marker IDs with corresponding particle emitter IDs.

Therefore, by using the particle emitter to generate computer graphics onto a live recording, an augmented reality of augmented images is presented to the audience such that the audience can be entertained for longer periods of time while awaiting for the main event or while enjoying the main event. In other words, the present advancement allows the audience to be more involved in the event itself because augmented images of the audience members themselves are being generated and displayed based on the markers displayed by the audience members and recorded by the imaging device 12. Further, the augmented images presented to the audience change based on changes in the position and orientation of the markers due to audience interaction and movement of the markers. Therefore, the audience members can see themselves and how their interactions with the markers effect the augmented images that are being produced on the display screen.

As would be recognized by one of ordinary skill in the art, any other type of graphical augmentation can be provided to the markers included in the scene imagery in addition to or separate from the particles emitted by the particle emitter. For example, computer-generated graphical rings could be added to the scene imagery such that they emanate from the markers themselves or provide ripple effects based upon an audience members interaction with the marker. Further, the image of the markers themselves could be enhanced such that they are graphically increased or decreased in size or multiply within the scene imagery. The markers themselves could also be distorted within the scene imagery to produce markers that appear stretched or squished or in any other form as would be understood by one of ordinary skill in the art. In addition, the scene imagery can be augmented by the addition of sound effects or music based on the identified marker and the interaction of the audience member with the marker. Further, the pitch, tone and/or amplitude of the sound effects and/or music that is used to augment the scene imagery can be based on the position, orientation and/or type of identified marker. For example, the rotation of the marker within the scene imagery can be used to control the pitch of the sound effects while the position of the marker within the scene imagery can be used to control the amplitude of the sound effects.

Referring back to FIG. 1 and as would be understood by one of ordinary skill in the art, the above-noted features with respect to the computer 2 could also be performed by the mobile device 8 to identify markers, determine whether the markers corresponds to a known pattern and augment the scene imagery when the markers corresponds to the known pattern. The augmented images could also be transmitted to the mobile device 8 or accessed via the internet by the mobile device 8 thereby providing enhanced entertainment for audience members.

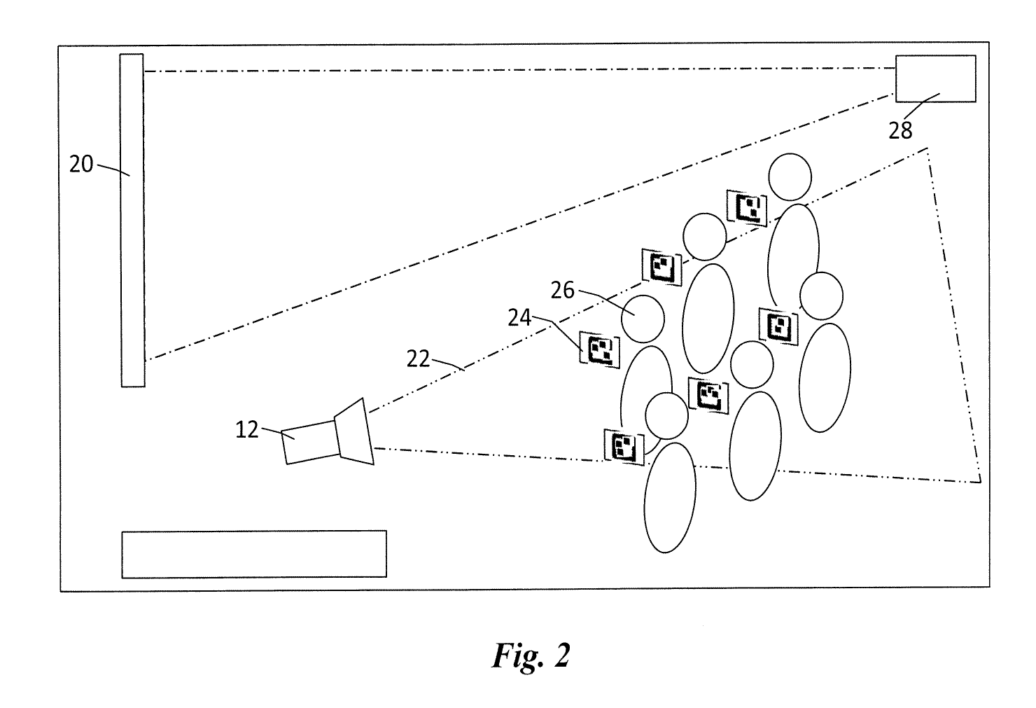

FIG. 2 is a schematic diagram of a system for producing augmented images according to an exemplary embodiment of the present advancement. The imaging device 12 illustrated in FIG. 2 is the same as that illustrated in FIG. 1 and therefore like designations are repeated. As illustrated in FIG. 2, the imaging device 12 records image data of a scene within a frame 22 of the imaging device 12. The scene imagery includes a plurality of audience members 26 that each have different markers 24 positioned in the frame 22 of the imaging device 12. These markers 24 can be located on the audience members 26 themselves, such as on clothing and/or accessories, or could represent posters or other related items held by the audience members 26. The markers 24 can also be located on any other object within the scene imagery such as vehicles, buildings and trees. FIG. 2 also illustrates an image generating device 28 that displays the images recorded by the imaging device 12 onto a display screen 20. The audience members 26 and markers 24 recorded by the imaging device 12 are situated such that they face the display screen 20 so that they can see images reproduced on the display screen 20. In other words, the audience members 26 are able to see themselves on the display screen 20 based on a live recording of the imaging device 12 such that they can interact with the imaging device 12 and/or display screen 20 to produce different results on the display screen 20. For the ease of audience member interaction, the scene imagery recorded by the imaging device 12 is mirrored by the computer 2 before being displayed. As previously discussed, these features allow the crowd to become more actively involved in the event itself thereby reducing the risk that the crowd will lose interest in the content being displayed on the display screen 20 or will lose interest in the event itself.

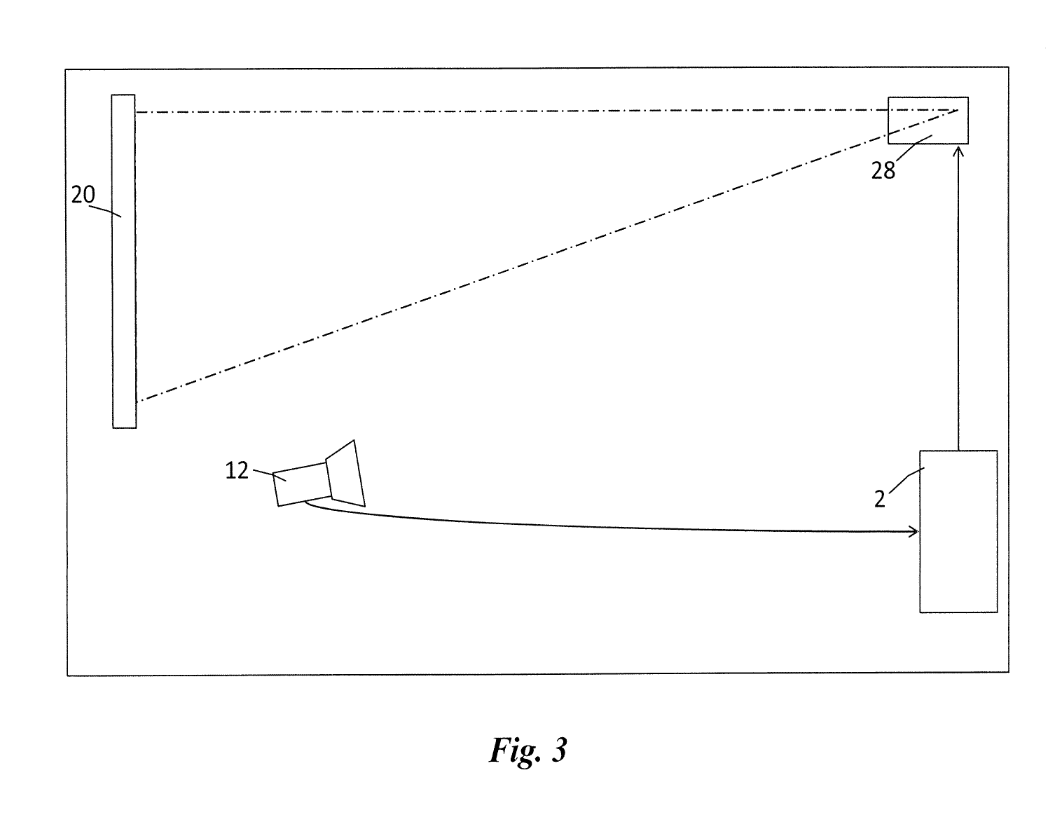

FIG. 3 illustrates an information flow diagram of a system for producing augmented images according to an exemplary embodiment of the present advancement. The computer 2 and the imaging device 12 of FIG. 1, and the display screen 20 and image producing device 28 of FIG. 2 are illustrated in FIG. 3 and therefore like designations are repeated. As illustrated in FIG. 3, the imaging device 12 is connected to the computer 2 and the computer 2 is connected to the image producing device 28. The audience members 26 and markers 24 recorded by the imaging device 12 are not shown in FIG. 3 such that the flow of information from the imaging device 12 can be demonstrated. Accordingly, the scene imagery of markers 24 and audience members 26 recorded by the imaging device 12 is sent to the computer 2 for processing. The images processed can be live images recorded by the imaging device 12 or images previously recorded by the imaging device 12. As discussed previously and as described in further detail below, the computer 2 identifies at least one marker 24 from the scene imagery received by the imaging device 12 and determines whether the marker 24 corresponds to a known pattern. When the marker 24 matches a known pattern, the scene imagery is graphically augmented by the computer 2, for example, such that the scene imagery sent to the image producing device 28 includes particles emitted from a position of the marker 24 in the scene imagery. As such, the audience members 26 will recognize themselves as well as the particles dispersed from their individual markers 24 on the display screen 20. If none of the markers 24 match any corresponding pattern and the computer 2 and/or server 4 cannot determine a match, the scene imagery recorded by the imaging device 12 will be passed unmodified to the image producing device 28 thereby displaying only the live scene recorded by the imaging device 12 on the display screen 20. Also, more than one marker 24 may be recognized and matched by the computer 2 and therefore the image scenery transmitted to the image producing device 28 to be displayed on the display screen 20 would include a plurality of different particle dispersions with respect to the markers 24 of the plurality of audience members 26.

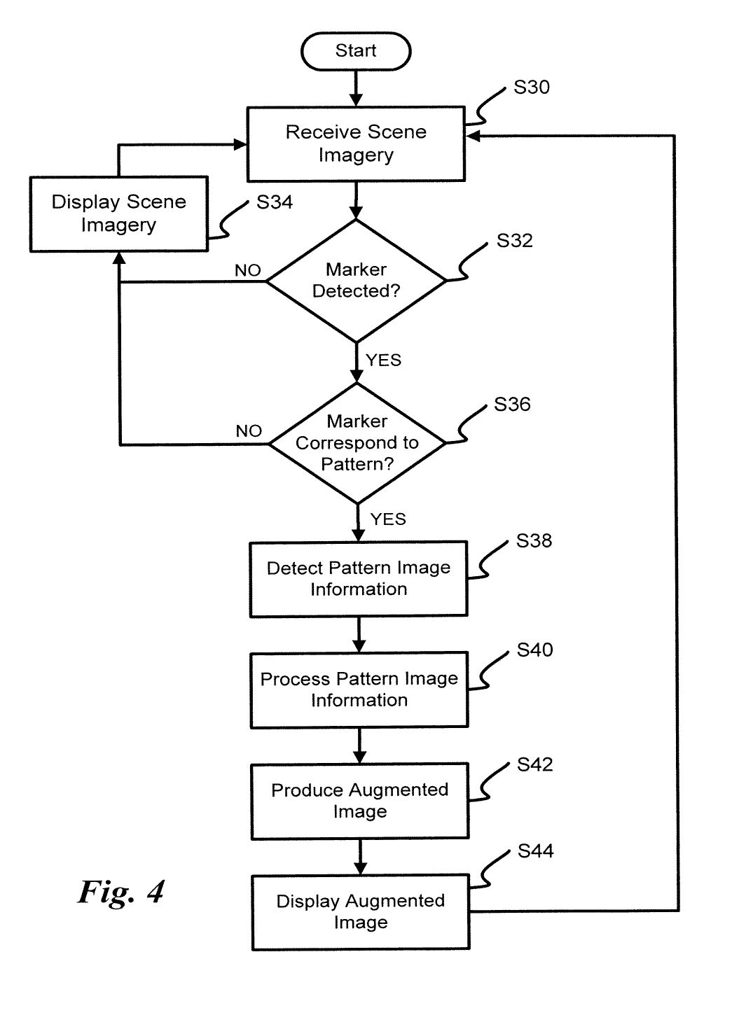

FIG. 4 is an algorithmic flowchart for producing augmented images according to an exemplary embodiment of the present advancement. In step S30, scene imagery is received from the image device 12 by the computer 2. At step S32, it is determined whether a marker 24 is identified in the scene imagery received from the imaging device 12. If a marker 24 is not identified, the scene imagery is displayed at step S34 and processing loops back to step S30 to receive further scene imagery. If at least one marker 24 is identified, processing proceeds to step S36 where it is determined via pattern matching whether or not the marker 24 correspond to a particular pattern. If it is determined that a marker 24 does not correspond to any known pattern, processing proceeds to step S34 to display the scene imagery recorded by the imaging device 12 and then processing further proceeds to step S30 to receive further scene imagery. If the marker 24 does correspond to a known pattern, processing proceeds to step S38 where image information with respect to the pattern is identified. Pattern image information relates to the content identified in the pattern that matched the identified marker 24 such as a brand name, picture or other identifying mark of the pattern. Pattern image information also relates to the size, color, shape and color, or any other related characteristic, of the pattern to be emitted by the particle emitter. Based on the pattern image information identified at step S38, the pattern image information is processed by the computer 2 and provided to the particle emitter. The particle emitter then generates computer graphics of particles or other graphical representations, based on the pattern image information, being dispersed from the position of the marker 24 in the received scene imagery thereby producing an augmented image at step S42. The augmented image is then displayed on the display screen 20 by the image producing device 28 for the entertainment of the audience members. Processing then proceeds back to step S30 to receive further scene imagery from the imaging device 12.

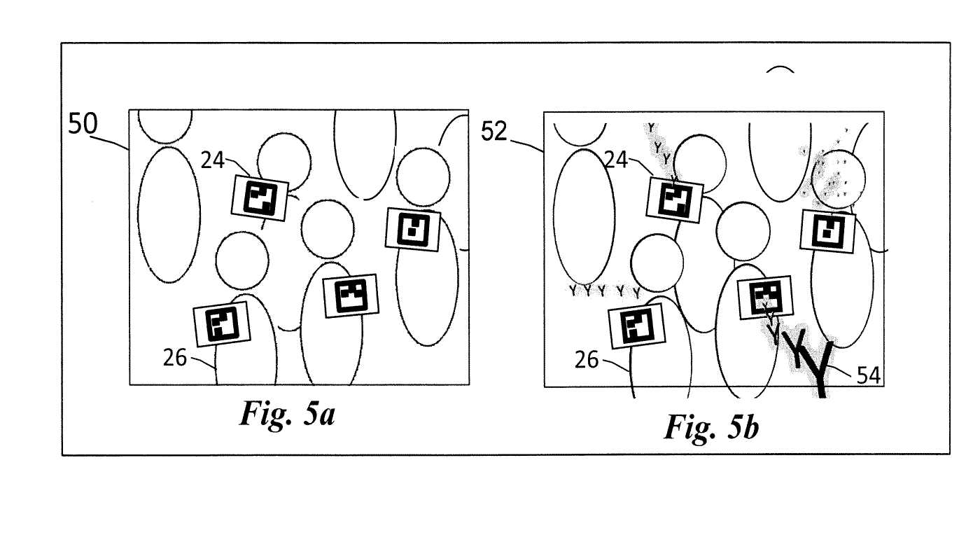

FIG. 5A is a schematic diagram of scene imagery 50 before augmentation according to an exemplary embodiment of the present advancement. As illustrated in FIG. 5a the scene imagery 50 recorded by the imaging device 12 and received by the computer 2 includes a plurality of audience members 26 and a plurality of markers 24 represented spatially at different locations based on the orientation of the imaging device 12 and the position and orientation of the markers 24. As discussed previously, the markers 24 are identified by the computer 2 based on the scene imagery data received from the imaging device 12 and the computer 2 determines whether the markers 24 correspond to a known pattern. Once it is determined that the markers 24 correspond to known patterns, the scene imagery 50 is augmented by the computer 2 with particles dispersed from the positions of the markers 24 in the scene imagery 12.

FIG. 5b illustrates an example of augmented scene imagery 52 having particles 54 dispersed from the markers 24. As illustrated in FIG. 5B, the particles 54 are emitted from the center of the marker 24 and can be dispersed in a variety of different ways. As such, particles 54 can be dispersed such that they appear to go towards or away from the camera view of the imaging device 12. For example, particles 54 may be dispersed in a direction “towards” the imaging device 12 in response to the marker 24 being moved closer to the imaging device 12 and may be dispersed in a direction “away” from the camera in response to the marker 24 being moved farther from the imaging device 12. The particles 54 can also move in any direction and can change direction whenever the position of the marker 24 in the received scene imagery changes. Further, any orientation change of the marker 24 causes the computer 2 to emit particle dispersions in different directions or at different angles. Further, the particles 54 dispersed, although represented as the letter Y in FIG. 5B, could be any type of imagery or identification symbol designated by the computer 2 based on the pattern image information. The particles 54 may be emitted as a group of particles, emitted one or more at a time or emitted as a particular shape based on the pattern image information. The particles 54 may also be emitted in a waveform or zig-zag shape, or any other shape that would be recognized by one of ordinary skill in the art. As the pattern image information may be different for different markers 24, a variety of different particles can be emitted for different markers 24 in different directions within the augmented scene imagery. If some of the markers 24 do not match a particular pattern, then the scene imagery is only augmented with particles 54 emitted from markers 24 with matching patterns. Further, the particles 54 can be dispersed such that they interact with each other by bouncing off of each other or bouncing off the “corners” of the screen display 20 or destroying each other based on the size of the dispersed particles 54. Markers 24 that go off the screen by going outside of the frame 22 of the imaging device 12 such that the pattern is no longer recognizable will cause their dispersion patterns to dissipate, transform or fade away to the point at which particles 54 are no longer emitted from the markers 24. Markers 24 that go off the screen can also cause the particle emitter to immediately stop particles from being emitted from the markers 24.

Accordingly, audience members 26 viewing the augmented scene imagery are much more engaged during the time leading up to the main event as well as during the event itself because the audience members are actively included in the presentation via the display screen 20. In other words, instead of merely seeing themselves on the display screen 20, audience members 26 can see a variety of particle dispersions emitted from markers 24 displayed by the audience members 26 that change based on the direction, size, orientation and movement of the markers 24. Further, in order to better engage the audience, markers 24 that are positioned at a more direct angle with respect to the imaging device 12 can have particles 54 displayed more prominently than those particles 54 of markers 24 that are displayed at an angle such that the imaging device 12 does not get as good a view of the markers 24. For example, a marker positioned 180 degrees from the lens of the imaging device 12 and oriented perpendicular to the field of view of the lens will emit particles 54 that are darker, less transparent or larger than particles 54 of other markers 24 positioned at less direct angles with respect to the lens of the imaging device 12. The orientation and position of the markers with respect to the imaging device 12 can also affect the speed and direction of particles 54 emitted from the markers 24. Further, the particles 54 may also be dispersed in directions indicated by the movement of the audience members 26. For example, an audience member 26 moving a marker 24 in a figure-eight direction will cause particles 54 to be emitted in a figure-eight direction from the marker 24 at a speed based upon the speed at which the marker 24 was moved in the figure-eight direction by the audience member 26.

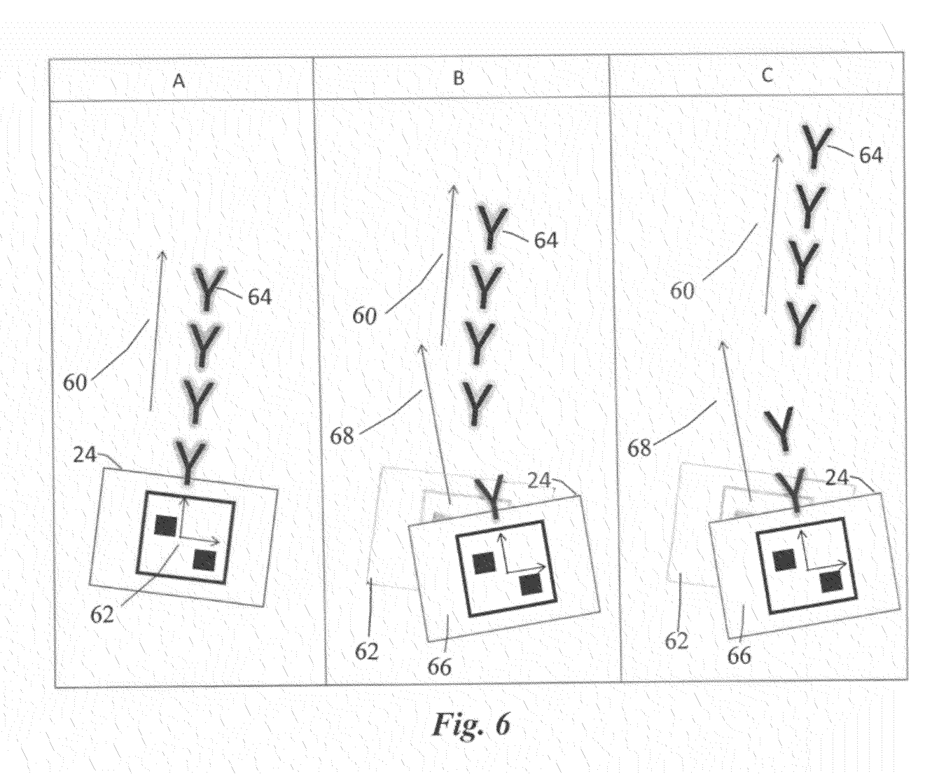

FIG. 6 is a step diagram for producing augmented scene imagery according to an exemplary embodiment of the present advancement. As illustrated in step A of FIG. 6, particles 64 are dispersed from marker 24 in a first direction 60 based upon the orientation and position 62 of the marker 24 with respect to the viewing angle of the imaging device 12. In step B, the orientation and position 62 of the marker 24 is changed such that a new orientation and position 66 of marker 24 is recorded by the imaging device 12. In this new position and orientation 66, particles 64 are no longer dispersed in the first direction 60 but are instead dispersed in a second direction 68 based on the new orientation and position 66 of the marker 24. With respect to step C, FIG. 6 illustrates that particles 64 will continue to be dispersed in the second direction 68 while the orientation and position 66 of the marker 24 remains unchanged. However, the particles 64 dispersed when the marker 24 was at the first orientation and position 62 continue in the first direction 60 as that was the direction at which the particles 64 were emitted from the orientation and position 62. Accordingly, any particles 64 emitted while the marker 24 is at the orientation and position 66 will continue in the second direction 68 until the position and orientation of the marker 24 is changed at which point the particles 64 are dispersed in a different direction. Therefore, the audience members 26 benefit from a variety of particle dispersion directions based on their interaction with the markers 24.

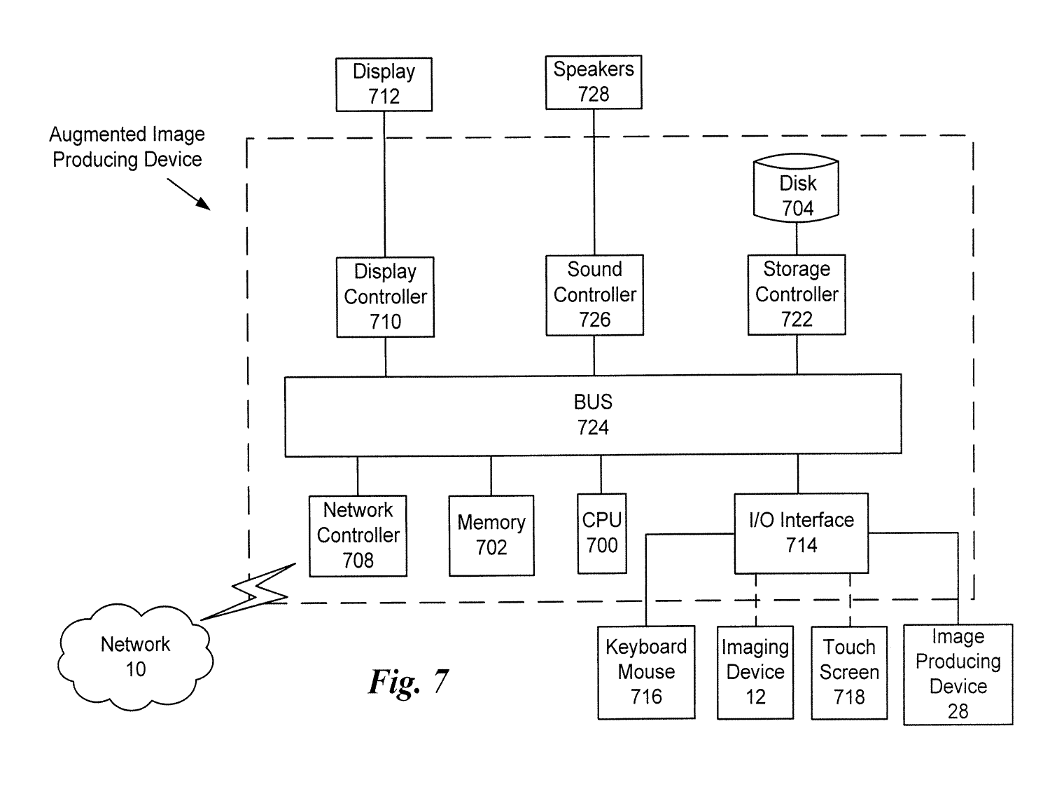

Next, a hardware description of the augmented image producing device according to exemplary embodiments is described with reference to FIG. 7. In FIG. 7, the augmented image producing device includes a CPU 700 which performs the processes described above. The process data and instructions may be stored in memory 702. These processes and instructions may also be stored on a storage medium disk 704 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the augmented image producing device communicates, such as a server or computer.

Further, the claimed advancements may be provided as a utility application, background daemon, or component of an operating system, or combination thereof, executing in conjunction with CPU 700 and an operating system such as Microsoft Windows 7, UNIX, Solaris, LINUX, Apple MAC-OS and other systems known to those skilled in the art.

CPU 700 may be a Xenon or Core processor from Intel of America or an Opteron processor from AMD of America, or may be other processor types that would be recognized by one of ordinary skill in the art. Alternatively, the CPU 700 may be implemented on an FPGA, ASIC, PLD or using discrete logic circuits, as one of ordinary skill in the art would recognize. Further, CPU 700 may be implemented as multiple processors cooperatively working in parallel to perform the instructions of the inventive processes described above.

The augmented image producing device in FIG. 7 also includes a network controller 708, such as an Intel Ethernet PRO network interface card from Intel Corporation of America, for interfacing with network 10. As can be appreciated, the network 10 can be a public network, such as the Internet, or a private network such as an LAN or WAN network, or any combination thereof and can also include PSTN or ISDN sub-networks. The network 10 can also be wired, such as an Ethernet network, or can be wireless such as a cellular network including EDGE, 3G and 4G wireless cellular systems. The wireless network can also be WiFi, Bluetooth, or any other wireless form of communication that is known.

The augmented image producing device further includes a display controller 710, such as a NVIDIA GeForce GTX or Quadro graphics adaptor from NVIDIA Corporation of America for interfacing with display 712, such as a Hewlett Packard HPL2445w LCD monitor. A general purpose I/O interface 714 interfaces with a keyboard and/or mouse 716 as well as a touch screen panel 718 on or separate from display 712. General purpose I/O interface also connects to a variety of peripherals 720 including printers and scanners, such as an OfficeJet or DeskJet from Hewlett Packard. In addition, the general purpose I/O interface connects with imaging devices 12, such as a Canon XH G1s, a Sony F65 or a cell phone camera to receive scene imagery and image producing devices 28, such as a projector, LCD, or Plasma display device.

A sound controller 726 is also provided in the augmented image producing device, such as Sound Blaster X-Fi Titanium from Creative, to interface with speakers/microphone 728 thereby providing sounds and/or music.

The general purpose storage controller 722 connects the storage medium disk 704 with communication bus 724, which may be an ISA, EISA, VESA, PCI, or similar, for interconnecting all of the components of the augmented image producing device. A description of the general features and functionality of the display 712, keyboard and/or mouse 716, as well as the display controller 710, storage controller 722, network controller 708, sound controller 726, and general purpose I/O interface 714 is omitted herein for brevity as these features are known.

Any processes, descriptions or blocks in flowcharts described herein should be understood as representing modules, segments, or portions of code which include one or more executable instructions for implementing specific logical functions or steps in the process, and alternate implementations are included within the scope of the exemplary embodiment of the present advancements in which functions may be executed out of order from that shown or discussed, including substantially concurrently or in reverse order depending upon the functionality involved.

Obviously, numerous modifications and variations of the present advancements are possible in light of the above teachings. In particular, while the application of the present advancement has been described with respect to events such as conventions, sports and concerts, other applications are within the scope of the appended claims. For example, without limitation, the present advancement may be applied to video games, TV, cell phones, tablets, web applications, and any other platform as would be understood by one of ordinary skill in the art. It is therefore to be understood that within the scope of the appended claims, the present advancements may be practiced otherwise than as specifically described herein.

1. An augmented image producing device, comprising:
a processor programmed to
receive scene imagery from an imaging device;
identify at least one marker in the scene imagery;
determine whether the at least one marker corresponds to a known pattern;
augment the scene imagery, in response to determining that the at least one marker corresponds to a known pattern, with particles dispersed from a position of the at least one marker; and
a display that displays the augmented scene imagery.

2. The augmented image producing device according to claim 1, wherein the particles interact based on relative movement of the at least one marker in the scene imagery.

3. The augmented image producing device according to claim 1, wherein a direction in which the particles are dispersed is based on an orientation of the at least one marker in the scene imagery with respect to the imaging device.

4. The augmented image producing device according to claim 1, wherein a size of the particles is based on a size of the at least one marker in the scene imagery.

5. The augmented image producing device according to claim 1, wherein a type of particle changes based on content contained within the at least one marker.

6. The augmented image producing device according to claim 2, wherein the scene imagery is only augmented with the particles dispersed from a position of the at least one marker when an entirety of the at least one marker is visible within the scene imagery.

7. The augmented image producing device according to claim 1, wherein first particles dispersed in a first direction continue moving in the first direction while second particles dispersed in a second direction, in response to a change in an orientation of the at least one marker in the scene imagery, move in the second direction.

8. The augmented image producing device according to claim 1, wherein a size of the particles is based on a distance of the at least one marker from the imaging device.

9. The augmented image producing device according to claim 1, wherein the particles are dispersed in a particular pattern corresponding to a pattern formed by movement of the at least one marker

10. The augmented image producing device according to claim 1, wherein particles are dispersed from the center of the at least one marker.

11. A method for producing an augmented image, comprising:
receiving scene imagery from an imaging device;
identifying at least one marker in the scene imagery;
determining whether the at least one marker corresponds to a known pattern;
augmenting, via a processor, the scene imagery, in response to determining that the at least one marker corresponds to a known pattern, with particles dispersed from a position of the at least one marker; and
displaying the augmented scene imagery.

12. The method according to claim 1, wherein the particles interact based on relative movement of the at least one marker in the scene imagery.

13. The method according to claim 1, wherein a type of particle changes based on content contained within the at least one marker.

14. The method according to claim 1, wherein a size of the particles is based on a size of the at least one marker in the scene imagery.

15. The method according to claim 1, wherein first particles dispersed in a first direction continue moving in the first direction while second particles dispersed in a second direction, in response to a change in an orientation of the at least one marker in the scene imagery, move in the second direction.

16. A non-transitory computer-readable medium storing computer readable instructions thereon that when executed by a processor cause the processor to perform a method for producing an augmented image, comprising:
receiving scene imagery from an imaging device;
identifying at least one marker in the scene imagery;
determining whether the at least one marker corresponds to a known pattern;
augmenting, via a processor, the scene imagery, in response to determining that the at least one marker corresponds to a known pattern, with particles dispersed from a position of the at least one marker; and
displaying the augmented scene imagery.

17. The non-transitory computer-readable medium according to claim 1, wherein the particles interact based on relative movement of the at least one marker in the scene imagery.

18. The non-transitory computer-readable medium according to claim 1, wherein a type of particle changes based on content contained within the at least one marker.

19. The non-transitory computer-readable medium according to claim 1, wherein a size of the particles is based on a size of the at least one marker in the scene imagery.

20. The non-transitory computer-readable medium according to claim 1, wherein first particles dispersed in a first direction continue moving in the first direction while second particles dispersed in a second direction, in response to a change in an orientation of the at least one marker in the scene imagery, move in the second direction.
